(19) United States
(12) Patent Application Publication
(10) Pub. No.: US 2013/0260040 A1
(43) Pub. Date: Oct. 3, 2013

(54) MICROENCAPSULATED CATNIP OIL AND METHODS OF USING THE SAME

(71) Applicants: Neil Werde, Broomfield, CO (US); Mark Hartelius, Denver, CO (US)

(72) Inventors: Neil Werde, Broomfield, CO (US); Mark Hartelius, Denver, CO (US)

(21) Appl. No.: 13/781,109

(22) Filed: Feb. 28, 2013

Related U.S. Application Data
(60) Provisional application No. 61/604,157, filed on Feb. 28, 2012.

(51) Int. Cl. B05C 1/02; B05D 3/12

(52) U.S. Cl. CPC B05C 1/02; B05D 3/12
USPC 427/355; 401/202; 401/196; 401/198

(57) ABSTRACT

Microencapsulated catnip oil comprising microcapsules in the range of 5-60 micrometers, apparatuses useful in the application of the microencapsulated catnip, and methods of using the same, are disclosed.

### CROSS REFERENCE TO RELATED APPLICATIONS

This application claims the benefit of U.S. Provisional Patent Application No. 61/604,157 filed Feb. 28, 2012, which is incorporated herein by reference in its entirety.

### FIELD

The present disclosure relates to microencapsulated catnip oil comprising microcapsules in the range of 5-60 micrometers, apparatuses useful in the application of the microencapsulated catnip, and methods of using the same.

### BACKGROUND

Nepetalactone is a bicyclic terpenoid (a ten-carbon compound derived from isoprene having two fused ring structures, a cyclopentane and a lactone) that naturally occurs in the plant Nepeta cataria, also known as catnip. Nepetalactone can be extracted from the Nepeta cataria plant effectively using steam distillation. Upon extraction, the rough distillate can be purified into a concentrated oil having nepetalactone as the main component. The resulting oil is commonly referred to as an essential oil of catnip, or simply catnip oil.

Nepetalactone is most commonly known for the behavioral effects it elicits in cats, both domestic and wild (e.g., tigers, lions and the like). In essence, nepetalactone acts as a feline attractant and will have a pharmacological effect on approximately one third of all cats placed in contact with it. The terpenoid is ingested by the cat via the olfactory system, where it makes contact with receptors present on the olfactory epithelium. The receptors trigger an internal pharmacological effect in the cat that can vary widely from animal to animal and is dependent upon the amount of catnip ingested. Typical pharmacological effects include drooling, sleepiness, anxiety, increased locomotor activity (e.g., leaping, running) and purring. Higher levels of exposure can cause aggressive behavior in some cats, however, making them hiss, growl, meow, scratch, or bite. The duration of the effects of nepetalactone is typically short, lasting for about 1-2 hours. On average a cat will be sensitive to a further dose of nepetalactone approximately two hours after exposure to the first dose, though this will vary from individual to individual.

Nepetalactone, typically in the form of catnip oil, is widely used as a recreational substance for domesticated and pet cats. Products that incorporate catnip oil and/or are laced with catnip oil are quite popular and commercially available.

### SUMMARY

Therefore, microencapsulated catnip oil, and products incorporating microencapsulated catnip oil, for the use and enjoyment of domesticated cats are useful.

In various aspects, the present disclosure is based on the discovery that the microencapsulation process can be refined to generate microcapsules comprising catnip oil across a wide range of diameters. For example, in various aspects the present disclosure provides a microencapsulation process that can generate microcapsules comprising catnip oil, wherein each microcapsule has a diameter falling within the range of 5 micrometers (μm)-60 μm.

In various aspects, the present disclosure is based on the discovery that the microencapsulation process can be refined to generate microcapsules comprising catnip oil, wherein each microcapsule has a diameter falling within the range of 5 μm-10 μm.

In some aspects, the present disclosure provides a marker, comprising a cylindrical outer case closed at one end, a source of microencapsulated catnip oil, a tip, and a housing.

In some embodiments, the source of microencapsulated catnip oil fits inside of, and is completely contained within, the outer case.

In some embodiments, the housing secures the tip to the open end of the outer case and places the tip in fluid connection with the source of microencapsulated catnip oil.

In some embodiments, the microencapsulated catnip oil is configured to flow from the source to the tip and out of the marker.

In some embodiments, the marker comprises a cap.

In some embodiments, the tip comprises porous pressed fibers selected from felt and nylon.

In some embodiments, the source of microencapsulated catnip oil comprises a reservoir.

In some embodiments, the microencapsulated catnip oil comprises microcapsules having a diameter falling within the range of 5 μm-60 μm. In some embodiments, the microencapsulated catnip oil comprises microcapsules having a diameter falling within the range of 5 μm-10 μm.

In some embodiments, elongated outer case is closed at one end by a cap secured in place by directional threading.

In some embodiments, the source comprises a cartridge made of an absorbent material selected from cotton, wool, felt, nylon and combinations thereof. In some embodiments, the absorbent material is cotton.

In some embodiments, the cartridge is soaked in a solution comprising the microencapsulated catnip oil.

In some aspects, the present disclosure provides a felt tip pen, comprising a cylindrical outer case closed at one end, a source of microencapsulated catnip oil, a tip, and a housing.

In some embodiments, the source of microencapsulated catnip oil fits inside of, and is completely contained within, the outer case.

In some embodiments, the housing secures the tip to the open end of the outer case and places the tip in fluid connection with the source of microencapsulated catnip oil.

In some embodiments, the microencapsulated catnip oil is configured to flow from the source to the tip and out of the felt tip pen.

In some embodiments, the felt tip pen comprises a cap.

In some embodiments, the tip comprises porous pressed fibers selected from felt and nylon.

In some embodiments, the source of microencapsulated catnip oil comprises a reservoir.

In some embodiments, the microencapsulated catnip oil comprises microcapsules having a diameter falling within the range of 5 μm-60 μm. In some embodiments, the microencapsulated catnip oil comprises microcapsules having a diameter falling within the range of 5 μm-10 μm.

In some embodiments, the elongated outer case is closed at one end by a cap secured in place by directional threading.

In some embodiments, the source comprises a cartridge made of an absorbent material selected from cotton, wool, felt, nylon and combinations thereof. In some embodiments, the absorbent material is cotton.

In some embodiments, the cartridge is soaked in a solution comprising the microencapsulated catnip oil.

In some aspects, the present disclosure provides a fountain pen, comprising an elongated outer case closed at one end, an internal reservoir of microencapsulated catnip oil, a nib, a feed in fluid connection with the reservoir and the nib, and a housing.

In some embodiments, the internal reservoir is configured to fit inside of, and be completely contained within, the outer case.

In some embodiments, the feed comprises a cylindrical body in fluid connection with the reservoir and the nib.

In some embodiments, the feed is configured to allow the microencapsulated catnip oil to flow from the internal reservoir to the nib.

In some embodiments, the feed is an integral part of the nib.

In some embodiments, the microencapsulated catnip oil comprises microcapsules having a diameter falling within the range of 5 μm-60 μm. In some embodiments, the microencapsulated catnip oil comprises microcapsules having a diameter falling within the range of 5 μm-10 μm.

In some aspects, the present disclosure provides an ink cartridge, comprising a reservoir of microencapsulated catnip oil.

In some embodiments, the microencapsulated catnip oil is configured to flow from the reservoir to an inkjet printer.

In some embodiments, the microencapsulated catnip oil comprises microcapsules having a diameter falling within the range of 5 μm-60 μm. In some embodiments, the microencapsulated catnip oil comprises microcapsules having a diameter falling within the range of 5 μm-10 μm.

In some embodiments, the microencapsulated catnip oil comprises an adhesive.

In some aspects, the present disclosure provides a spray bottle, comprising a reservoir of microencapsulated catnip oil, a positive displacement pump, and a nozzle having an opening.

In some embodiments, the positive displacement pump comprises a siphon tube configured to draw the microencapsulated catnip oil from the reservoir.

In some embodiments, the positive displacement pump forces the microencapsulated catnip oil through the nozzle.

In some embodiments, the opening of the nozzle is adjustable.

In some embodiments, the microencapsulated catnip oil comprises microcapsules having a diameter falling within the range of 5 μm-60 μm. In some embodiments, the microencapsulated catnip oil comprises microcapsules having a diameter falling within the range of 5 μm-10 μm.

In some embodiments, the microencapsulated catnip oil comprises an adhesive.

In some aspects, the present disclosure provides an atomizer, comprising a reservoir of microencapsulated catnip oil, a positive displacement pump, and a nozzle having an opening.

In some embodiments, the positive displacement pump comprises a siphon tube configured to draw the microencapsulated catnip oil from the reservoir.

In some embodiments, the positive displacement pump forces the microencapsulated catnip oil through the nozzle.

In some embodiments, the opening of the nozzle is adjustable.

In some embodiments, the microencapsulated catnip oil comprises microcapsules having a diameter falling within the range of 5 μm-60 μm. In some embodiments, the microencapsulated catnip oil comprises microcapsules having a diameter falling within the range of 5 μm-10 μm.

In some embodiments, the microencapsulated catnip oil comprises an adhesive.

In some aspects, the present disclosure provides a dauber, comprising a container having a single opening and that is configured to contain a volume of microencapsulated catnip oil, a tip, and a housing.

In some embodiments, the housing comprises a cap configured to house the tip and close the opening.

In some embodiments, the housing secures the tip such that one side of the tip faces the interior of the container and another side of the tip is exposed to the air.

In some embodiments, the tip comprises an absorbent material selected from cotton, wool, felt, nylon, sponge, and combinations thereof.

In some embodiments, the microencapsulated catnip oil comprises microcapsules having a diameter falling within the range of 5 μm-60 μm. In some embodiments, the microencapsulated catnip oil comprises microcapsules having a diameter falling within the range of 5 μm-10 μm.

In some embodiments, the microencapsulated catnip oil comprises an adhesive.

In some aspects, the present disclosure provides methods of spraying paper with microencapsulated catnip oil, comprising spraying microencapsulated catnip oil onto a single side of a first piece of paper, spraying microencapsulated catnip oil onto a single side of a second piece of paper, placing the sprayed side of the first piece of paper in contact with the sprayed side of the second piece of paper, and separating the first and second pieces of paper.

In some embodiments, the microencapsulated catnip oil comprises a wet solution.

In some embodiments, the methods comprise, after the step of placing, drying the microencapsulated catnip oil.

In some embodiments, the microencapsulated catnip oil comprises comprising a plurality of microcapsules of catnip oil and an adhesive.

In some embodiments, the adhesive holds the sprayed side of the first piece of paper in contact with the sprayed side of the second piece of paper until the step of separating.

In some embodiments, the step of separating breaks at least about 75% of the microcapsules of the microencapsulated catnip oil.

In some embodiments, the microencapsulated catnip oil comprises microcapsules having a diameter falling within the range of 5 μm-60 μm. In some embodiments, the microencapsulated catnip oil comprises microcapsules having a diameter falling within the range of 5 μm-10 μm.

### DETAILED DESCRIPTION

### Definitions

“Catnip oil” means an oil comprising nepetalactone as the main component. The definition includes essential oils comprising nepetalactone extracted from natural sources such as the Nepeta cataria plant, valerian (Valeriana officinalis) and plants that contain actinidine or dihydroactinidiolide; and also includes oils comprising chemically synthesized nepetalactone as the main component.

“Microcapsule” means a small sphere generated by a microencapsulation process comprising an internal component with a uniform wall surrounding it. In various aspects the internal component comprises catnip oil, as defined herein. In certain embodiments, a microcapsule has a diameter falling within the range of 5 μm-60 μm. In certain embodiments, a microcapsule has a diameter falling within the range of 5 μm-10 μm.

“Micrometer” means one one-millionth of a meter, or 1×10⁻⁶ meters. In this disclosure the terms “micron” and “μm” are used synonymously with micrometer.

Reference is now made in detail to certain embodiments of microencapsulated catnip oil, apparatuses comprising microencapsulated catnip oil and related methods of use. The disclosed embodiments are not intended to be limiting of the claims. To the contrary, the claims are intended to cover all alternatives, modifications, and equivalents.

In various aspects, the present disclosure provides microencapsulated catnip oil as well as apparatuses useful in the application of the microencapsulated catnip and methods of using the apparatuses.

In certain embodiments, the microencapsulated catnip oil comprises microcapsules having a diameter falling within the range of 5 μm-60 μm. In certain embodiments, the microencapsulated catnip oil comprises microcapsules having a diameter falling within the range of 5 μm-10 μm.

In various aspects, the present disclosure provides an apparatus suitable for administration of the microencapsulated catnip oil disclosed herein. In that regard, the present disclosure provides an apparatus comprising the microencapsulated catnip oil disclosed herein. In certain embodiments, the apparatus is selected from a writing implement and an atomizing sprayer. In certain embodiments, the writing implement is selected from a marker, a felt tip pen and a fountain pen. In certain embodiments, the atomizing sprayer is selected from a hand powered spray bottle, a perfume atomizer and an automated spray gun such as, for example, an airbrush.

In various aspects, the present disclosure provides methods of using the aforementioned apparatuses to apply the microencapsulated catnip oil disclosed herein. In certain embodiments, the methods comprise contacting the microencapsulated catnip oil with a reservoir of an apparatus such that the microencapsulated catnip oil is contained in the reservoir, and operating the apparatus to expel the microencapsulated catnip oil from the apparatus.

### Microencapsulation

In various aspects, the present disclosure relates to processes for producing microencapsulated materials by an oil-in-water microencapsulation process, whereby microcapsules are formed which contain oil-based material. In certain embodiments, the oil-based material comprises catnip oil.

Numerous processes have been elucidated for producing microencapsulated materials, many of which produce microcapsules of materials contained in a water-immiscible or water-insoluble material. a number of microencapsulation processes produce microcapsules using an “oil-in-water” microencapsulation processes. Briefly, an oil-in-water microencapsulation process involves the production of a dispersion or emulsion of oil, or similar organic substance that is substantially water-immiscible, as liquid droplets in an aqueous medium. The oil droplets are commonly referred to as the discontinuous phase and the aqueous medium is commonly referred to as the continuous phase. Prior to contact with the aqueous medium, one or more monomers or prepolymers are added to the oil. Microcapsules are then formed by subjecting the dispersion or emulsion to conditions that are sufficient to cause polymerization of the monomers or prepolymers present in the oil. Any number of conditions may be employed for this purpose, depending upon the selection of monomers or prepolymers present in the oil. Suitable conditions include, for example, change in temperature, change in pH and/or agitation. The end result is that microcapsules are produced in the aqueous medium having a polymeric shell enclosing small volumes of the oil or discontinuous phase.

In certain embodiments, catnip oil can be microencapsulated within microcapsules by a process comprising:

generating a discontinuous phase material comprising catnip oil and a prepolymer intermediate;

generating a continuous phase comprising water and a surface-active agent;

contacting the discontinuous phase with the continuous phase;

creating an emulsion of the discontinuous phase in the continuous phase, wherein the emulsion comprises discrete droplets of the discontinuous phase dispersed in the continuous phase and whereby an interface is formed between the discrete droplets of the discontinuous phase and the surrounding continuous phase; and

triggering in situ self-condensation and curing of the prepolymer at the interface by altering at least one physical property of the emulsion and maintaining the changed condition for a sufficient period of time to allow each discrete droplet to become encased within a polymeric microcapsule.

In some embodiments, the physical property is selected from pH and temperature.

In some embodiments, the discontinuous phase comprises one or more additives. In some embodiments, the continuous phase comprises one or more additives. In some embodiments, both the discontinuous phase and the continuous phase comprise one or more additives.

In certain embodiments, catnip oil can be microencapsulated within microcapsules by a process comprising:

generating a discontinuous phase comprising catnip oil and an organic isocyanate prepolymer intermediate;

generating a continuous phase comprising water;

contacting the discontinuous phase with the continuous phase;

establishing a physical dispersion of the discontinuous phase in the continuous phase, thereby generating droplets of the discontinuous phase of desired size in the continuous phase; and

altering the pH and temperature of the dispersion;

wherein altering the pH and temperature of the resulting mixture causes a condensation reaction of the isocyanate prepolymer intermediate to occur at an interface between the droplets of the discontinuous phase and the surrounding continuous phase, encasing each droplet in a polymeric microcapsule.

In some embodiments, the discontinuous phase comprises one or more additives. In some embodiments, the continuous phase comprises one or more additives. In some embodiments, both the discontinuous phase and the continuous phase comprise one or more additives.

In certain embodiments, catnip oil can be microencapsulated within microcapsules by any one or more of the microencapsulation processes described in U.S. Pat. Nos. 8,039,015; 6,932,984; 5,418,010; 5,407,609; 5,277,979; and 5,225,278.

Discontinuous Phase

In various aspects, the discontinuous phase is substantially immiscible in the continuous phase, in that a large proportion of the discontinuous phase does not form a solution with the continuous phase. The chemical nature of the discontinuous phase is organic, or largely carbon-based. It is this chemical nature that makes the discontinuous phase hydrophobic, or less soluble in water-based solvents than in an organic solvent.

In various aspects, the discontinuous phase comprises catnip oil. In certain embodiments, the catnip oil is substantially immiscible and/or insoluble in the continuous phase. For example, the solubility of the catnip oil under ambient conditions can be approximately 5,000 parts per million by weight or less. The catnip oil may consist of a single liquid material or one or more active liquid or solid materials dissolved in an inert solvent which has, at most, a slight solubility or miscibility in the continuous phase. In some embodiments, when the discontinuous phase and the continuous phase are in equilibrium, the catnip oil is present in the discontinuous (organic) phase, not the continuous (aqueous) phase.

In various aspects, the discontinuous phase comprises catnip oil and one or more prepolymers. In certain embodiments, the discontinuous phase is generated by combining catnip oil and one or more prepolymers in an organic solvent. The one or more prepolymers may be available for commercial purchase predissolved in an organic solvent. In that regard, generation of the discontinuous phase can occur by combining catnip oil and the one or more predissolved prepolymers. In some embodiments, the organic solvent the catnip oil is dissolved in can be used as a solvent for the one or more prepolymers.

In some embodiments, the discontinuous phase exists as two separate solutions that are added simultaneously to the continuous phase. In certain embodiments, a first solution comprises catnip oil dissolved in an organic solvent. In certain embodiments, a second solution comprises one or more prepolymers dissolved in an organic solvent. In certain embodiments, the organic solvent of the first solution is the same as the organic solvent of the second solution.

In some embodiments, polar organic solvents may be utilized to generate the discontinuous phase. Suitable polar organic solvents include, for example, alcohols, ketones, esters, aromatics and combinations thereof. In some embodiments, non-polar solvents such as aliphatics, hydrocarbons or a combination thereof can be used to generate the discontinuous phase.

The amount of the discontinuous phase used in the methods disclosed herein can vary. In some embodiments, the amount of discontinuous phase used in the instant methods can vary from about 1% to about 75% of the total volume used in the methods. In some embodiments, the amount of discontinuous phase used in the instant methods can vary from about 25% to about 50% of the total volume. In some embodiments, the discontinuous phase is present as about 50% of the total volume. In some embodiments, the discontinuous phase is present as about 55% of the total volume.

In certain embodiments, the catnip oil does not react with the prepolymer of the discontinuous phase or any of the other components utilized in the foregoing methods.

Continuous Phase

In various aspects, the continuous phase is substantially immiscible in the discontinuous phase, in that a large proportion of the continuous phase does not form a solution with the discontinuous phase. The chemical nature of the continuous phase is aqueous; it is a solution that comprises water as the main, or only, solvent. It is this chemical nature that makes the continuous phase hydrophilic, or soluble in water-based solvents and substantially insoluble or immiscible in organic solvents. In some embodiments, one or more of the components comprising the discontinuous phase may be slightly soluble in water. For example, one or more of the components comprising the catnip oil disclosed herein may have a slight solubility in water. Usually the amount of solubility in water will be minor and will not affect the outcome of the microencapsulation process.

In various aspects, the continuous phase comprises water. In certain embodiments, the water is substantially immiscible and/or insoluble in the discontinuous phase. The continuous phase may consist of a single liquid material or one or more active liquid or solid materials dissolved in an aqueous solvent which has, at most, a slight solubility or miscibility in the discontinuous phase.

The purity of the water used to generate the continuous phase can vary. In some embodiments, the water used may be tap water, or water that is otherwise publicly available. In some embodiments, the water may be deionized. In some embodiments, the water is distilled once prior to generation o the continuous phase, in some embodiments the water is distilled twice, and in some embodiments the water is triple distilled. In some embodiments, the water is filtered. Any commercially available water filter may be used for this purpose including, for example, carbon based filters, membrane-based filters, osmotic filters, or a combination of any of the foregoing.

In various aspects, the continuous phase comprises water and one or more additives, as described herein. In certain embodiments, the continuous phase is generated by combining water and one or more additives. The additives may be available for commercial purchase predissolved in an aqueous or water-based solvent. In that regard, generation of the continuous phase can occur by combining water and the one or more predissolved additives. In some embodiments, the additives can be contacted with water directly to form the continuous phase.

In some embodiments, the continuous phase is generated by producing, using simple agitation, a solution of water, one or more surfactants and one or more colloids, as described below. The continuous phase so generated is essentially free of any components that will react with the components of the discontinuous phase or any other materials present in the microencapsulation process. In some embodiments, the one or more surfactants and the one or more colloids do not interfere with the generation o the polymeric microcapsule wall.

The amount of the continuous phase used in the methods disclosed herein can vary. In some embodiments, the amount of continuous phase used in the instant methods can vary from about 1% to about 75% of the total volume used in the methods. In some embodiments, the amount of continuous phase used in the instant methods can vary from about 25% to about 50% of the total volume. In some embodiments, the continuous phase is present as 50% of the total volume.

In certain embodiments, the water does not react with the additives of the continuous phase or any of the other components utilized in the foregoing methods.

Prepolymers and Polymers

The prepolymers selected for use in the methods disclosed herein will determine the polymeric nature of the resulting microcapsules. Prepolymers will react with each other under certain conditions to generate, or grow, one or more polymers. For example, certain prepolymers will react under acidic conditions to generate large polymers, and certain prepolymers will react under basic conditions to generate large polymers. Prepolymers may be selected to suit the particular application and/or for ease of use in polymerization. For example, a prepolymer or combination of prepolymers can be selected to generate a non-porous, rigid polymer microcapsule. Alternately, a prepolymer or combination of prepolymers can be selected to generate non-porous, flexible polymer microcapsules. Additionally, a prepolymer or combination of prepolymers can be selected to generate microporous polymer microcapsules.

A variety of prepolymers from synthetic and/or natural sources can be used to generate the polymers of the microcapsules. A polymeric microcapsule can be made from a polymer comprising one prepolymer monomer or subunit or from a polymer comprising a plurality of prepolymer monomers or subunits. Microcapsules can also be made from prepolymers that react to form polymers comprising more than one monomer or subunit thus forming a co-polymer, terpolymer, etc. For example, lactic or polylactic acid and be combined with glycolic acid or polyglycolic acid to form the copolymer poly(lactide-co-glycolide).

The polymer(s) may be natural polymers, biological polymers, synthetic polymers, or a combination thereof. In various embodiments, prepolymers are selected to generate the polymers of the microcapsules wherein the polymers are selected from aliphatic polyesters, polyhydroxyalkanoates, polyurethanes, polyalkylene oxides, polydimethylsiloxane, polyvinylalcohol, polyvinylpyrrolidone, polylysine, collagen, gelatin, laminin, fibronectin, elastin, alginate, fibrin, hyaluronic acid, proteoglycans, polypeptides, polysaccharides and combinations thereof.

In some embodiments, prepolymers are selected to generate a microcapsule comprising a single polymer. In some embodiments, prepolymers are selected to generate a microcapsule comprising two different polymers or subunits. In some embodiments, prepolymers are selected to generate a microcapsule comprising three different polymers or subunits. In some embodiments, prepolymers are selected to generate a microcapsule comprising four different polymers or subunits. In some embodiments, prepolymers are selected to generate a microcapsule comprising five different polymers or subunits. In each such embodiment, the polymers can be selected from aliphatic polyesters, polyhydroxyalkanoates, polyurethanes, polyalkylene oxides, polydimethylsiloxane, polyvinylalcohol, polyvinylpyrrolidone, polylysine, collagen, gelatin, laminin, fibronectin, elastin, alginate, fibrin, hyaluronic acid, proteoglycans, polypeptides, polysaccharides and combinations thereof.

The aliphatic polyesters can be linear or branched. In some embodiments, the aliphatic polyester is linear and is selected from D-lactic acid, L-lactic acid, lactide, poly(lactic acid), poly(lactide) glycolic acid, poly(glycolic acid), poly(glycolide), glycolide, poly(lactide-co-glycolide), poly(lactic acid-co-glycolic acid), polycaprolactone and combinations thereof. In some embodiments, the aliphatic polyester is branched and is selected from D-lactic acid, L-lactic acid, lactide, poly(lactic acid), poly(lactide) glycolic acid, poly(glycolic acid), poly(glycolide), glycolide, poly(lactide-co-glycolide), poly(lactic acid-co-glycolic acid), polycaprolactone and combinations thereof. In some embodiments, the aliphatic polyester is conjugated to an additive.

In some embodiments, the polyalkylene oxide is selected from polyethylene oxide, polyethylene glycol, polypropylene oxide, polypropylene glycol and combinations thereof.

In some embodiments, the prepolymers are selected to generate polymers, and thus microcapsules, that are biodegradable. In some embodiments, the microcapsules provided by the present disclosure comprise biodegradable polymers. In some embodiments, the biodegradable polymers comprise a monomer which is a member selected from lactic acid and glycolic acid. In some embodiments, the biodegradable polymers are poly(lactic acid), poly(glycolic acid) or a copolymer thereof. In some embodiments, the biodegradable polymers are those which are approved by the FDA for clinical use, such as poly(lactic acid) and poly(glycolic acid).

In some embodiments, the prepolymers are selected to generate a microcapsule that is gelatin-based. Gelatin is a mixture of peptides and proteins that is produced by partial hydrolysis of collagen. Collagen may be chemically synthesized or it may be extracted from any one or more natural substances such as, for example, skin, bones, connective tissues, and internal organs. The hydrolysis of collages results in the chemical bonds between individual collagen strands being broken down into a form that re-polymerizes more readily. Gelatin melts to a liquid when heated and solidifies to form a semi-rigid, largely non-porous polymer when cooled. Therefore, in some embodiments, the prepolymers comprise collagen and related components that form gelatin as the shell of the microcapsule upon cooling.

In some embodiments, the prepolymer comprises a polyisocyanate. In some embodiments, the prepolymer comprises one or more polyisocyanates. The nature of the polyisocyanate(s) selected will determine the release properties of the microcapsule as well as its structural integrity. In some embodiments, the polyisocyanates are selected from: aromatic polyisocyanates such as, for example, aromatic diisocyanates; aliphatic diisocyanates; high molecular weight linear aliphatic diisocyanates; and isocyanate pre-polymers. Polyisocyantes suitable for use in the methods provided by the present disclosure include, without limitation: 1-Chloro-2,4-phenylene diisocyanate, m-Phenylene diisocyanate, p-Phenylene diisocyanate, 4,4′-Methylenebis(phenyl isocyanate), 2,4-Tolylene diisocyanate, Tolylene diisocyanate (60% 2,4-isomer, 40% 2,6-isomer), 2,6-Tolylene diisocyanate, 3,3′-Dimethyl-4,4′-biphenylene diisocyanate, 4,4′-Methylenebis(2-methylphenyl isocyanate), 3,3′-Dimethoxy-4,4′-biphenylene diisocyanate, 2,2′,5,5′-Tetramethyl-4,4′-biphenylene diisocyanate, 80% 2,4- and 20% 2,6-isomer of tolylene diisocyanate, Polymethylene polyphenylisocyanate (PAPI), and combinations thereof.

In some embodiments, more than one of the foregoing polyisocyanates are selected for use in the disclosed methods. In certain embodiments, a combination of polyisocyanates comprises polymethylene polyphenylisocyanate and tolylene diisocyanate, containing 80% 2,4- and 20% 2,6-isomers.

The amount of the prepolymer polyisocyanate(s) used in the disclosed microencapsulation processes can vary. In some embodiments, the amount of prepolymer polyisocyanate is greater than about 2% by weight. In some embodiments, the amount of prepolymer polyisocyanate is from about 2% to about 75% by weight. In some embodiments, the amount of prepolymer polyisocyanate is from about 5% to about 50% by weight.

In some embodiments, the prepolymer comprises an etherified urea-formaldehyde prepolymer. In some embodiments, the prepolymer comprises one or more partially etherified urea-formaldehyde prepolymers. Partially etherified urea-formaldehyde prepolymers display high solubility in the discontinuous phase and low solubility in the continuous phase. In non-etherified form, these prepolymers contain a large number of methylol groups. Etherification is performed on these prepolymers to replace the hydroxyl hydrogens with alkyl groups, and is achieved by condensation of the prepolymers with an alcohol. When the alkyl groups comprise four carbon atoms or more and they have replaced more than about 50% of the hydroxyl hydrogen atoms on the prepolymer molecules, the prepolymer becomes soluble in the discontinuous phase. Complete etherification is not necessary, however, since, in some embodiments, hydroxyl groups are needed for in situ self-condensation polymerization.

Therefore, in some embodiments, the partially etherified urea-formaldehyde prepolymers are those in which about 50% to about 98% of the hydroxyl hydrogen atoms have been replaced by C₄₋₁₀ alkyl groups. In some embodiments, the partially etherified urea-formaldehyde prepolymers are those in which about 70% to about 90% of the hydroxyl hydrogen atoms have been replaced by C₄₋₁₀ alkyl groups. Both straight-chain and branched-chain alkyls may be used, and all carbon atom ranges are inclusive of their upper and lower limits.

The concentration of the partially etherified urea-formaldehyde prepolymers in the discontinuous phase can vary depending on the size and wall strength of the microcapsule desired. In some embodiments, the prepolymer concentration is from about 1% to about 70%, by weight. In some embodiments, the prepolymer concentration is from about 5% to about 50%, by weight.

Etherified urea-formaldehyde prepolymers are commercially available as solutions in alcohol or in a mixture of alcohol and xylene. Urea-formaldehyde prepolymers which have not been etherified are also available commercially, either in aqueous solutions or as water-dissolvable solids, for use as adhesives. These can be etherified by condensation with the desired alcohol in a weakly acidic alcohol solution. The water of condensation is distilled off as an azeotrope with the alcohol until the desired degree of condensation (etherification) has been reached.

Additives

In various embodiments, the discontinuous phase may comprise one or more additives. In various embodiments, the continuous phase may comprise one or more additives. In various embodiments, both the discontinuous phase and the continuous phase may comprise one or more additives. Suitable additives may include solvents, polymerization catalysts, adhesives, wall-modifying agents, surface-active agents, colloids and combinations thereof.

In some embodiments, the discontinuous phase and the continuous phase comprise different additives. In some embodiments, the discontinuous phase and the continuous phase comprise different combinations of additives. In some embodiments, the discontinuous phase and the continuous phase comprise the same additives. In some embodiments, the discontinuous phase and the continuous phase comprise the same combinations of additives.

In some embodiments, solvents provide a means for controlling and modifying the reaction that generates the wall of the microcapsules. In some embodiments, the wall-generating reaction occurs when protons (H⁺) come in contact with the prepolymer(s). The discontinuous phase, which in some embodiments comprises catnip oil, must be slightly hydrophilic so that it attracts protons to the interface formed between the droplets of the discontinuous phase and the surrounding continuous phase from the bulk of the aqueous phase, yet also sufficiently hydrophobic to prevent large amounts of protons from crossing the interface and causing wall polymerization to occur within the droplet. An appropriately selected solvent added to the discontinuous phase can create the desires properties in the discontinuous phase needed to achieve these results. In some embodiments, the solvent of the discontinuous phase comprises aliphatic solvents, alicyclic solvents, alcohols, ketones and combinations thereof. The amount of solvent can be varied as needed to achieve the desired results.

In some embodiments, the discontinuous phase, continuous phase, or both comprise one or more catalysts capable of enhancing the wall-forming reaction. In some embodiments, catalysts can be used to enhance the wall-forming reaction when the discontinuous phase is highly hydrophobic (for example, when the discontinuous phase comprises catnip oil) as catalysts attract protons toward the discontinuous phase. In some embodiments, water-soluble catalysts that have a high affinity for the discontinuous phase and that are capable of carrying a proton can be used. Suitable catalysts include, for example, carboxylic acids, sulfonic acids, orthochlorobenzoic acid, 2-phenyl-2,2-dichloroacetic acid, benzoic acid, salicylic acid, p-toluenesulfonic acid and dodecylbenzene sulfonic acid. In some embodiments, salts of any one or more of the foregoing acids are dissolved in the discontinuous phase, the continuous phase, or both, and the pH of the continuous phase is lowered during microencapsulation.

In some embodiments, the discontinuous phase, continuous phase, or both comprise one or more adhesives. Adhesives can be added so that the resulting microcapsules will be sticky, whereby upon application of the microcapsules to a surface, the microcapsules will stick to the surface and remain in place. In some embodiments, the adhesive comprises one or more pressure sensitive adhesives, which form a bond between the microcapsules and the surface to which they are placed into contact, by the application of light pressure. In some embodiments, light pressure may be generated by the device used to apply the microcapsules to the surface. Once the adhesive and the surface are in close proximity, molecular interactions, such as van der Waals forces, become involved in the bond, contributing significantly to its ultimate strength. In some embodiments, the adhesive comprises one or more contact adhesives. Suitable contact adhesives include natural rubbers, polychloroprene, and combinations thereof.

In some embodiments, the discontinuous phase can comprise one or more wall-modifying agents. Wall-modifying agents serve to modify the character of the wall of the microcapsules by varying its permeability to the discontinuous phase. Wall-modifying agents can be added to the discontinuous phase to increase the degree of cross-linking of the prepolymers or to decrease the number of active sites on the prepolymer and thus decrease the degree of cross-linking. The selection of the wall-modifying agents, as well as the ratio of the wall-modifying agent(s) in the discontinuous phase versus the prepolymer, the permeability of the wall of the microcapsule (and consequently the release rate of the contents of the microcapsule) can be either increased or decreased. Suitable wall-modifying agents include, for example, castor oil, mercaptopropionate, and other poly-functional mercaptan esters of a similar nature can be used.

In some embodiments, the discontinuous phase, the continuous phase, or both, may comprise one or more surface-active agents. In certain embodiments, surface-active agents comprise a compound having properties that lower the surface tension of a fluid interface, such as that generated between the droplets of the discontinuous phase and the surrounding continuous phase. In some embodiments, the surface-active agent comprises nonionic agents, anionic agents, or a combination thereof. Suitable nonionic agents include, for example, long chain alkyls, mercaptan polyethoxy alcohols, alkylaryl polyethoxy alcohols, alkylaryl polyether alcohols, alkyl polyether alcohols, polyoxyethylene sorbitan fatty acid esters, polyoxyethylene ethers, polyethylene glycol esters with fatty or rosin acids, and combinations thereof. Suitable anionic agents include, for example, calcium, amines, alkanolamine, alkali salts of alkyl- and alkylaryl-sulfonates, vegetable sulfonates, ethoxylated and propoxylated mono- and di-ethers of phosphoric acid, and combinations thereof. In some embodiments, the surface-active agents are selected from polyethelene glycol ethers of linear alcohols, alkali salts of alkyl- and alkylaryl-sulfonates, and combinations thereof.

In some embodiments, the surface-active agents comprise one or more surfactants. Suitable surfactants can comprise, for example, nonionic, anionic, or cationic surfactants having a hydrophile-lipophile balance (HLB) range of from about 12 to about 16. Examples of surfactants falling within this HLB range include, without limitation, sodium isopropyl naphthalene sulfonates, polyoxyethylenesorbitol oleate laurates, ethoxylated nonylphenols, polyethylene glycol ethers of linear alcohols, and combinations thereof.

The quantity of surface-active agent can vary. In some embodiments, the amount of surface-active agent ranges from about 0.1% to about 5% by weight of the phase the agent is added to. In some embodiments, the amount of surface-active agent ranges from about 0.01% to about 3.0% by weight of the phase the agent is added to.

In some embodiments, the stability of the emulsion or dispersion created during microencapsulation can be enhanced by adding one or more colloids to the continuous phase. Colloids are known to stabilize an emulsion and/or a dispersion and prevent droplet aggregation, flocculation, and coalescense. Thus, colloids can be added to maintain a fine dispersion of droplets of discontinuous phase in the surrounding continuous phase. Suitable colloids include, for example, polyacrylates, polyacrylamide, polyvinyl alcohols, alginates, alpha- and gamma-proteins, casein, methyl cellulose, carboxymethyl cellulose, gelatin, glues, natural gums, polyacids, poly(methylvinyl ether), poly(maleic anhydride), and combinations thereof. Additional compounds which can serve as suitable colloids include, for example, sodium lignin sulfonate, potassium lignin sulfonate, magnesium lignin sulfonate, calcium lignin sulfonate, ammonium lignin sulfonate, and combinations thereof; Treax®, Treax.LTS, Treax.LTK, Treax.LTM, and combinations thereof which are, respectively, the potassium, magnesium and sodium salts of lignosulfonate (50% aqueous solutions) (Scott Paper Co., Forest Chemical Products); Marasperse CR® and Marasperse CBOS-3®, sodium lignosulfonate, American Can Co.; Polyfon O®, Polyfon T®, Reax 88B®, Reax 85B®, sodium salts of lignin sulfonate and Reax C-21®, calcium salt of lignin sulfonate, Westvaco Polychemicals; Orzan S and Orzan A, the sodium and ammonium salts of lignosulfonate, ITT Rayonier, Inc., and combinations of any one or more of the foregoing.

In some embodiments, the colloid(s) can be added to the continuous phase prior to the formation of the emulsion or dispersion. In some embodiments, the colloid(s) can be added to the continuous phase once the emulsion or dispersion has been formed. In some embodiments, the colloid(s) can be added to the continuous phase prior to contact with the discontinuous phase. In some embodiments, the colloid(s) can be added after formation of the emulsion or dispersion. In some embodiments, the colloid(s) can be added to the continuous phase prior to contact with the discontinuous phase and also after formation of the emulsion or dispersion.

The amount of colloid used can vary. In some embodiments, the amount of colloid added to the continuous phase ranges from about 0.1 & to about 5%, by weight.

Emulsion and Dispersion Formation

Once the discontinuous phase is put into contact with the continuous phase, an emulsion and/or a dispersion is formed by generating droplets of the discontinuous phase in the continuous phase. In various embodiments, an emulsion and/or a dispersion is a mixture of the discontinuous phase and the continuous phase, which comprise two liquids that are normally immiscible. In the emulsions and/or dispersions contemplated by the disclosure, the discontinuous phase, which in some embodiments comprises catnip oil, is dispersed in the continuous phase.

An emulsion and/or a dispersion of the discontinuous phase in the surrounding continuous phase can be formed in any one or more of ways. In some embodiments, the emulsion and/or dispersion is generated by the input of energy selected from: mechanical agitation such as shaking or stirring; high-shear stifling; homogenizing; sonicating; or combinations of any of the foregoing. In some embodiments, the emulsion and/or dispersion is generated by injecting the discontinuous phase into the continuous phase. Injection can occur by any number of means including, for example, by forced air, syringe injection, or combinations thereof. In some embodiments, injection is accomplished by way of forced air, wherein a high energy source of air is used to generate droplets of the discontinuous phase and force those droplets into the continuous phase. In some embodiments, the high energy sir source is selected from an air compressor and an airbrush.

In some embodiments, the emulsion and/or dispersion is generated by adding the discontinuous phase to the continuous phase while stifling the continuous phase. Upon addition of the discontinuous phase to the continuous phase, a suitable dispersing means is employed to generate an emulsion and/or dispersion of the discontinuous phase in the continuous phase. Any suitable high shear device can be used. Once the desired droplet size is obtained, the dispersing means discontinued. Only mild agitation is required for the balance of the process.

In various aspects, the size of the droplets of the discontinuous phase in the continuous phase can be varied. The present inventors have discovered that the use of a high energy air source can generate microcapsules having a very small diameter. In particular, the size of the aperture of the nozzle of a high energy air source can be adjusted to generate a very fine mist of the discontinuous phase. The smaller the aperture, the finer the mist. In some embodiments, a high energy air source can be used to generate a fine mist of the discontinuous phase. In some embodiments, the more fine the mist generated by the high energy air source, the smaller the resulting droplets of the discontinuous phase will be. In some embodiments, the size of the microcapsules ranges from about 0.5 μm to about 4000 μm in diameter. In some embodiments, the size of the microcapsules ranges from about 1 μm to about 100 μm in diameter. In certain embodiments, the microencapsulated catnip oil comprises microcapsules having a diameter falling within the range of 5 μm-60 μm. In certain embodiments, the microencapsulated catnip oil comprises microcapsules having a diameter falling within the range of 5 μm-10 μm.

Once the desired droplet size is attained, mild agitation is generally sufficient to prevent droplet growth throughout the microencapsulation process.

Microcapsule Formation

After the emulsion and/or dispersion is generated, the droplets of the discontinuous phase are encased in a polymeric shell, thereby creating microcapsules.

In some embodiments, microcapsule formation is accomplished by interfacial polycondensation, whereby two reactants are placed into contact at the interface formed between the droplets of the discontinuous phase and the surrounding continuous phase react rapidly. The basis of this reaction lies in the reaction between an acid chloride and a compound containing an active hydrogen atom, such as an amine or alcohol, polyesters, polyurea, or polyurethane. Under appropriate conditions, thin flexible polymer walls form instantaneously at the interface.

In some embodiments, microcapsule formation is accomplished by interfacial cross-linking, whereby one or more small, bifunctional monomers containing active hydrogen atoms are replaced by a polymer. When the reaction is performed at the interface of the emulsion and/or dispersion, an acid chloride reacts with one or more functional groups of the prepolymer(s), leading to the formation of a shell. The cross-linked polymers for a shell or microcapsule around a droplet of discontinuous phase.

In some embodiments, microcapsule formation is accomplished by in situ polymerization, whereby direct polymerization of one or more prepolymers is carried out on the surface of a droplet of discontinuous phase. In some embodiments, the generation of the polymeric shell occurs at a rate of about 0.5 m/min. The thickness of the shell generated by this process can vary. In some embodiments, the thickness ranges from about 0.2 μm to about 75 μm.

In some embodiments, microcapsule formation is accomplished by matrix polymerization, whereby a material is imbedded in the polymeric matrix during formation of the microcapsules. An example of this type of process is spray-drying, in which microcapsules are formed by evaporation of the solvent or by a chemical change.

In some embodiments, microcapsules can be formed by adding one or more catalysts to the continuous phase after the emulsion and/or dispersion is formed. In such embodiments, the majority of the polymerization reaction takes place at the interface, where the catalyst is present. In some embodiments, the microencapsulation procedure is performed at about room temperature, about 15° C. to about 30° C.

In some embodiments, microcapsule formation occurs through interfacial polymerization. Interfacial polymerization form the walls of the microcapsules by hydrolysis of an isocyanate monomer to form an amine, which in turn reacts with another isocyanate monomer to form a polymeric polyurea enclosure. During hydrolysis of the isocyanate monomer, carbon dioxide is created. Thereafter, formation of the polymeric polyurea enclosure around the emulsified and/or dispersed discontinuous phase droplets occurs by heating the continuous phase, by introducing a catalytic compound, and/or by adjusting the pH of the emulsion or dispersion, thereby triggering the condensation reaction at the interface. In some embodiments, the catalytic compound is selected from a basic amine, tri-n-butyl tin acetate, and combinations thereof.

The temperature of the interfacial condensation reaction can vary. In some embodiments, after the emulsion and/or dispersion is generated, the temperature is raised to about 40° C. to about 60° C. In some embodiments, the temperature range for the condensation reaction is between about 20° C. to about 90° C. In some embodiments, the heat to initiate the reaction can be applied to the dispersion of the discontinuous phase as it is being put into contact with the continuous phase. In some embodiments, the heat to initiate the reaction can be applied simultaneously or immediately after the pH of the emulsion is adjusted. In some embodiments, the heat to initiate the reaction can be applied to the continuous phase prior to addition of the discontinuous phase.

The interfacial condensation reaction can occur quite rapidly, with the majority of the generation of microcapsules occurring within the first one-half hour of reaction time. In some embodiments, to ensure completion of the reaction, the interfacial condensation reaction is allowed to continue for about 2 to about 3 hours. At the completion of the condensation reaction, all of the droplets of the discontinuous phase will be enclosed in a polymeric microcapsule wall. In some embodiments, the encapsulated material is immediately usable, with no further processing required.

In some embodiments, microcapsule formation occurs through in situ polymerization. In various embodiments, once the desired droplet size is attained, the pH of the emulsion and/or dispersion system is adjusted. In some embodiments, the emulsion and/or dispersion is acidified to a pH of between about 0 and about 4.0, and in some embodiments between about 1.0 and about 3.0. This causes the etherified urea-formaldehyde prepolymers to polymerize by self-condensation in situ and from a shell completely enclosing each droplet. Acidification can be accomplished by any suitable means, including, for example, adding a water-soluble acid to the emulsion and/or dispersion. Suitable acids include, for example, formic acid, citric acid, hydrochloric acid, sulfuric acid, phosphoric acid, and combinations thereof. Acidification can also be achieved by the use of acidic dispersants or surface-active agents, which, in some embodiments, are added to the system after the emulsion has been formed.

The rate of the in situ self-condensation polymerization reaction can vary. In some embodiments, the reaction rate increases with acidity, with temperature, or with both. In some embodiments, the reaction can be conducted at a temperature falling anywhere within the range of about 20° C. to about 100° C., in some embodiments between about 40° C. and about 70° C. The reaction will generally be complete within a few hours, although with high acidity and high temperature, the reaction can be completed within minutes.

As the microencapsulation process proceeds, the polymer wall of the nascent microcapsules will become more rigid and thus contact between the active groups on the prepolymer becomes increasingly more difficult and will eventually drop to zero. Thus, in situ self-condensation polymerization is self-terminating and, in some embodiments, is allowed to run to completion. The reaction can be arrested before completion, however, by raising the pH. In this manner, the wall tightness, rigidity, and permeability can be controlled. This can also be accomplished in most cases by a wall modifier as described above.

Once the microcapsules are formed, they can be stored for a period up to, and including, 6 weeks. The microcapsules can be used as an aqueous dispersion, or filtered and recovered as dried microcapsules. In various embodiments, the microcapsules are utilized in an aqueous dispersion and are stabilized in the dispersion by one or more dispersants. Suitable dispersants include, for example, lignin sulfonates, polymeric alkylnaphthalene sulfonates, sodium naphthalene sulfonate, polymethylene bis-naphthalene sulfonate, and sodium N-methyl N-(long chain acid) taurates.

Through the methods disclosed herein, fully formed, discrete microcapsules are formed having a range of diameters corresponding to the individual diameters of the droplets of the discontinuous phase. It is not necessary to separate the microcapsules from the continuous phase prior to use. The microcapsules are directly usable. However, separation prior to use may be carried out by any one or more known means. Suitable separation means include, for example, settling, filtration, skimming of the collected microcapsules, washing and, if desired, drying.

### Uses of Microencapsulated Catnip Oil

In various aspects, the present disclosure provides microencapsulated catnip oil comprising microcapsules having a diameter falling within the range of 5 μm-60 μm. In certain embodiments, the microencapsulated catnip oil comprises microcapsules having a diameter falling within the range of 5 μm-10 μm.

In various aspects, the present disclosure provides microencapsulated catnip oil comprising microcapsules with an adhesive on the outer surface.

In various aspects, the present disclosure provides apparatuses suitable for administration of the microencapsulated catnip oil disclosed herein. In that regard, the present disclosure provides an apparatus comprising the microencapsulated catnip oil disclosed herein. In certain embodiments, the apparatus is selected from a writing implement and an atomizing sprayer. In certain embodiments, the writing implement is selected from a marker, a felt tip pen and a fountain pen. In certain embodiments, the atomizing sprayer is selected from a hand powered spray bottle, a perfume atomizer and an automated spray gun such as, for example, an airbrush.

In various aspects, the present disclosure provides methods of using the aforementioned apparatuses to apply the microencapsulated catnip oil disclosed herein. In certain embodiments, the methods comprise contacting the microencapsulated catnip oil with a reservoir of an apparatus such that the microencapsulated catnip oil is contained in the reservoir, and operating the apparatus to expel the microencapsulated catnip oil from the apparatus.

Markers and Felt-Tip Pens

Markers and felt-tip pens are writing instruments that have their own ink source and a tip comprising porous, pressed fibers, such as felt or nylon. Ink flows from the ink source through the tip when the tip is placed into contact with an external source. The ink source is typically contained within a container running the length of the body of the marker or felt-tip pen. The ink source may be a direct extension of the tip material itself, such that the tip and the ink source are generated from a single continuous pressed material. In such a case, the ink source and the tip are impregnated with ink prior to use. The ink source may also be a self-contained reservoir that terminates in the tip such that the tip is the only direction for ink to flow from the reservoir. Ink flows from the reservoir, through the tip, and onto an external source when in use.

Markers and felt-tip pens are traditionally cylindrical in shape, although variations on the shape are common. Typically, a marker or felt-tip pen comprises a cylindrical outer case that is closed at one end, an ink source that fits inside of and is completely contained within the outer case, a tip, and a housing. The housing secures the tip to the open end of the outer case and also provides means for the tip to be in fluid connection with the ink source, while also closing off the remainder of the open end of the marker or felt tip pen so that the only possible way in which the ink may leave the open end of the outer case is through the tip. Optionally a marker or felt tip pen may include a cap that covers the tip when not in use.

Markers and felt tip pens are well known. Examples of markers include Crayola® products such as Broad Line Markers, Fine Line Markers, Washable Markers; Sharpie® markers, and the like. Examples of felt-tip pens include Paper Mate® Flair felt tip pens, Sharpie® fine point pens, Sanford® PMOP felt tip pens, and the like.

In various aspects, the present disclosure provides a marker comprising microencapsulated catnip oil. In that regard, the microencapsulated catnip oil is used in the marker in place of ink. When in use, the tips of the markers of the present disclosure draw microencapsulated catnip oil from a microencapsulated catnip oil source, through the tip, and out of the marker to an external source. In that regard, the markers provided by the present disclosure “write” microencapsulated catnip oil.

In certain embodiments, the present disclosure provides a marker comprising its own source of microencapsulated catnip oil and a tip. In some embodiments, the tip comprises porous, pressed fibers selected from felt and nylon. In some embodiments, microencapsulated catnip oil flows from the source of microencapsulated catnip oil through the tip when the tip is placed into contact with an external source. In some embodiments, the source of microencapsulated catnip oil and the tip are made from the same material and both the source and tip are impregnated with microencapsulated catnip oil prior to use. In some embodiments, the source of microencapsulated catnip oil is a self-contained reservoir that terminates in the tip such that the tip is the only direction for microencapsulated catnip oil to flow from the reservoir. In both embodiments, the source of microencapsulated catnip oil is contained within an outer case of the marker.

In certain embodiments, the present disclosure provides a marker comprising an elongated outer case that is closed at one end, a source of microencapsulated catnip oil that fits inside of the outer case, and is completely contained within, the outer case, a tip, and a housing for the tip. In certain embodiments, the housing secures the tip to the open end of the outer case and places the tip in fluid connection with the source of microencapsulated catnip oil. In some embodiments, the housing also seals the open end of the elongated outer case, leaving only the tip exposed. In certain embodiments, the microencapsulated catnip oil flows from the source, through the tip and out of the marker to an external source. The external source may include, for example, paper, cardboard, paperboard, and the like. In some embodiments, the marker comprises a cap configured to cover the tip.

In certain embodiments, the present disclosure provides a marker comprising an elongated outer case, a source of microencapsulated catnip oil that fits inside of, and is completely contained within, the outer case, a tip, and a housing for the tip. In certain embodiments, the elongated outer case comprises a cap that is configured to completely close off the end of the elongated case distal to the tip. The cap may be secured in place at the end of the elongated case by any number of means including, for example, directional screw-like threading, a press fit, an O-ring, and the like. In certain embodiments, the housing secures the tip to the end of the outer case opposite to the end closed by the cap and places the tip in fluid connection with the source of microencapsulated catnip oil. In some embodiments, the housing also seals the open end of the elongated outer case, leaving only the tip exposed. In certain embodiments, the source comprises a cartridge made of an absorbent material selected from cotton, wool, felt, nylon and combinations thereof. In some embodiments, the cartridge is soaked in a solution comprising the microencapsulated catnip oil and then placed inside of the outer case. In some embodiments, the source comprises a cotton cartridge. In some embodiments, the source is a cotton cartridge soaked in a solution comprising the microencapsulated catnip oil and inserted into the outer casing such that the cartridge is placed into contact with the tip by the housing. In certain embodiments, the microencapsulated catnip oil flows from the source, through the tip and out of the marker to an external source. The external source may include, for example, paper, cardboard, paperboard, and the like. In some embodiments, the marker comprises a cap configured to cover the tip.

In various aspects, the present disclosure provides a felt tip pen comprising microencapsulated catnip oil. In that regard, the microencapsulated catnip oil is used in the felt tip pen in place of ink. When in use, the tips of the felt tip pens of the present disclosure draw microencapsulated catnip oil from a microencapsulated catnip oil source, through the tip, and out of the felt tip pen to an external source. In that regard, the felt tip pens provided by the present disclosure “write” microencapsulated catnip oil.

In certain embodiments, the present disclosure provides a felt tip pen comprising its own source of microencapsulated catnip oil and a tip. In some embodiments, the tip comprises porous, pressed fibers selected from felt and nylon. In some embodiments, microencapsulated catnip oil flows from the source of microencapsulated catnip oil through the tip when the tip is placed into contact with an external source. In some embodiments, the source of microencapsulated catnip oil and the tip are made from the same material and both the source and tip are impregnated with microencapsulated catnip oil prior to use. In some embodiments, the source of microencapsulated catnip oil is a self-contained reservoir that terminates in the tip such that the tip is the only direction for microencapsulated catnip oil to flow from the reservoir. In both embodiments, the source of microencapsulated catnip oil is contained within an outer case of the felt tip pen.

In certain embodiments, the present disclosure provides a felt tip pen comprising an elongated outer case that is closed at one end, a source of microencapsulated catnip oil that fits inside of, and is completely contained within, the outer case, a tip, and a housing for the tip. In certain embodiments, the housing secures the tip to the open end of the outer case and places the tip in fluid connection with the source of microencapsulated catnip oil. In some embodiments, the housing also seals the open end of the elongated outer case, leaving only the tip exposed. In certain embodiments, the microencapsulated catnip oil flows from the source, through the tip and out of the felt tip pen to an external source. The external source may include, for example, paper, cardboard, paperboard, and the like. In some embodiments, the felt tip pen comprises a cap configured to cover the tip.

In certain embodiments, the present disclosure provides a felt tip pen comprising an elongated outer case, a source of microencapsulated catnip oil that fits inside of, and is completely contained within, the outer case, a tip, and a housing for the tip. In certain embodiments, the elongated outer case comprises a cap that is configured to completely close off the end of the elongated case distal to the tip. The cap may be secured in place at the end of the elongated case by any number of means including, for example, directional screw-like threading, a press fit, an O-ring, and the like. In certain embodiments, the housing secures the tip to the end of the outer case opposite to the end closed by the cap and places the tip in fluid connection with the source of microencapsulated catnip oil. In some embodiments, the housing also seals the open end of the elongated outer case, leaving only the tip exposed. In certain embodiments, the source comprises a cartridge made of an absorbent material selected from cotton, wool, felt, nylon and combinations thereof. In some embodiments, the cartridge is soaked in a solution comprising the microencapsulated catnip oil and then placed inside of the outer case. In some embodiments, the source comprises a cotton cartridge. In some embodiments, the source is a cotton cartridge soaked in a solution comprising the microencapsulated catnip oil and inserted into the outer casing such that the cartridge is placed into contact with the tip by the housing. In certain embodiments, the microencapsulated catnip oil flows from the source, through the tip and out of the marker to an external source. The external source may include, for example, paper, cardboard, paperboard, and the like. In some embodiments, the marker comprises a cap configured to cover the tip.

Fountain Pens

A fountain pen is a nib pen that contains an internal reservoir of water-based liquid ink. The internal reservoir is typically contained within an outer case of the fountain pen and runs the length of the body of the fountain pen. The pen draws ink from the reservoir through a feed to a nib and deposits it on paper via a combination of gravity and capillary action. As a result, the typical fountain pen requires little or no pressure to write.

Filling the reservoir with ink may be done manually (via the use of an eyedropper or syringe), or via an internal “filler” mechanism which creates suction to transfer ink directly through the nib into the reservoir. Some fountain pens employ removable reservoirs in the form of pre-filled ink cartridges.

Fountain pens are traditionally cylindrical in shape, although variations on the shape are common. Typically, a fountain pen comprises a cylindrical outer case that is closed at one end, an internal reservoir of ink that fits inside of and is completely contained within the outer case, a nib, a feed that allows the ink to flow from the internal reservoir to a nib, and a housing. The housing secures the nib to the open end of the outer case and thus closes off the open end of the fountain pen so that the only possible way in which the ink may leave the fountain pen is through the nib. The feed is typically a cylindrical body that is in fluid connection with the ink reservoir and the nib.

Some nibs include a feed as an integral part of the nib. In such cases, the feed is inserted into the reservoir and the reservoir is secured to the nib itself, such as by directional, screw-like threading, so that, when assembled, the nib and ink reservoir form an enclosed unit. This enclosed unit is then secured to the outer case, such as by directional, screw-like threading, whereby the reservoir is contained in the outer case and the nib extends outward from the end of the fountain pen. Such pens have no need for a housing, as the nib itself closes off the open end of the outer case. Optionally, a fountain pen may include a cap that covers the nib when not in use.

Fountain pens are well known and have been in use since the 10^{th} century. Examples of fountain pens include Mont Blanc® products such as the Meisterstuck Classique Fountain Pen, the Boheme Noir Fountain Pen; the Parker® Im Black Gold Trim Fountain Pen; and the like.

In various aspects, the present disclosure provides a fountain pen comprising microencapsulated catnip oil. In that regard, the microencapsulated catnip oil is used in the fountain pen in place of ink. When in use, the nibs of the fountain pens of the present disclosure draw microencapsulated catnip oil from an internal reservoir, through the nib, and out of the pen to an external source. In that regard, the fountain pens provided by the present disclosure “write” microencapsulated catnip oil.

In certain embodiments, the present disclosure provides a fountain pen comprising an internal reservoir of microencapsulated catnip oil, a feed and a nib. In some embodiments, the nib comprises a fluid channel that is configured to allow the microencapsulated catnip oil to flow freely from the reservoir through the nib and out of the pens. In some embodiments, microencapsulated catnip oil flows from the reservoir, through the feed, and through the nib when the tip is placed into contact with an external source. In some embodiments, the nib comprises the feed and the reservoir is directly connected to the nib by directional, screw-like threading wherein the feed is inserted into the reservoir prior to such connection. In some embodiments, the connected nib and reservoir are directly connected to the outer case via directional, screw-like threading.

In certain embodiments, the present disclosure provides a fountain pen comprising an elongated outer case that is closed at one end, an internal reservoir of microencapsulated catnip oil that fits inside of, and is completely contained within, the outer case, a nib, a feed that is in fluid connection with the reservoir and the nib, and a housing for the nib. In some embodiments, the fountain pen comprises a cylindrical outer case closed at one end, an internal reservoir of microencapsulated catnip oil that fits inside of and is completely contained within the outer case, a nib, a feed that allows the microencapsulated catnip oil to flow from the internal reservoir to a nib, and a housing. In some embodiments, the housing secures the nib to the open end of the outer case. In some embodiments, the feed comprises a cylindrical body in fluid connection with the reservoir and the nib.

In certain embodiments, the nib comprises the feed as an integral part of the nib. In some embodiments, the portion of the nib comprising the feed is inserted into the reservoir and the reservoir is secured to the nib. In some embodiments, the securing is accomplished by directional, screw-like threading, so that, when assembled, the nib and ink reservoir form an enclosed unit with the feed contained inside of the reservoir. In some embodiments, the assembly comprising the nib, feed and reservoir is then secured to the outer case by directional, screw-like threading. In certain embodiments, the fountain pen comprises a cap configured to cover the nib.

Ink Cartridges

An ink cartridge or inkjet cartridge is a replaceable component of an inkjet printer that contains the ink that is deposited onto paper during printing. An ink cartridge typically contains one or more partitioned ink reservoirs and, in some models, electronic contacts and a chip that communicates with an inkjet printer.

Ink cartridges are well known. Examples of ink cartridges include Hewlett Packard® products such as the HP 60 Series Inkjet Cartridges, the HP LaserJet 35A Inkjet Cartridges; the Epson® AcuLaser CX11NF Standard Capacity; and the like.

In various aspects, the present disclosure provides an ink cartridge comprising microencapsulated catnip oil. In that regard, the microencapsulated catnip oil is used in the ink cartridge in place of ink. When in use, the ink cartridge draws microencapsulated catnip oil from an internal reservoir and delivers it for printing to an inkjet printer. In that regard, the ink cartridges provided by the present disclosure “print” microencapsulated catnip oil.

In certain embodiments, the present disclosure provides an ink cartridge comprising an internal reservoir of microencapsulated catnip oil. In some embodiments, microencapsulated catnip oil flows from the reservoir to an inkjet printer where it is deposited onto paper by the inkjet printer. In some embodiments, the ink cartridge comprises electronic contacts configured to electronically communicate with an inkjet printer. In some embodiments, the ink cartridges comprise a chip that is configured to communicate directly with an inkjet printer.

Hand Powered Spray Bottles and Atomizers

Spray bottles and atomizers are bottles that can squirt, spray or mist fluids contained in a reservoir. Modern spray bottles and atomizers use a positive displacement pump that acts directly on the liquid contained in a reservoir. The pump draws liquid up a siphon tube from the bottom of the reservoir and forces it through a nozzle. Depending on the spray bottle or atomizer, the nozzle may or may not be adjustable, so as to select between dispensing a stream, aerosolizing a mist, or dispensing a spray from the spray bottle or atomizer.

In a typical spray bottle or atomizer, the dispensing is powered by the user's efforts such that the mechanical actuation of the positive displacement pump by the user is what causes the liquid to be pulled from the reservoir and forced through the nozzle.

Spray bottles and atomizers are well known and have been in use for many years. Perfume atomizers have been used with regularity for the better part of this century and last and spray bottles are commonly used to house and dispense household cleaners.

In various aspects, the present disclosure provides a spray bottle comprising microencapsulated catnip oil. In that regard, the microencapsulated catnip oil is contained in and dispensed from a reservoir of the spray bottle. When in use, a positive displacement pump of the spray bottle draws the liquid from the reservoir, forces it through a nozzle, and delivers it at a distance from the nozzle. In that regard, the spray bottles provided by the present disclosure dispense microencapsulated catnip oil.

In certain embodiments, the present disclosure provides a spray bottle comprising a reservoir of microencapsulated catnip oil, a positive displacement pump and a nozzle. In some embodiments, the positive displacement pump is configured to draw microencapsulated catnip oil up a siphon tube of the pump from the bottom of the reservoir and force it through the nozzle. In some embodiments, the opening of the nozzle is adjustable. As the opening of the nozzle is made larger, the microencapsulated catnip oil is dispensed therethrough as a stream. As the opening of the nozzle is made smaller, the microencapsulated catnip oil is dispensed therethrough as an aerosolized mist. An intermediate opening of the nozzle causes the microencapsulated catnip oil to be dispensed from the nozzle as a spray.

In various aspects, the present disclosure provides an atomizer comprising microencapsulated catnip oil. In that regard, the microencapsulated catnip oil is contained in and dispensed from a reservoir of the atomizer. When in use, a positive displacement pump of the atomizer draws the microencapsulated catnip oil from the reservoir, forces it through a nozzle, and delivers it at a distance from the nozzle. In that regard, the atomizers provided by the present disclosure dispense microencapsulated catnip oil.

In certain embodiments, the present disclosure provides an atomizer comprising a reservoir of microencapsulated catnip oil, a positive displacement pump and a nozzle. In some embodiments, the positive displacement pump is configured to draw microencapsulated catnip oil up a siphon tube of the pump from the bottom of the reservoir and force it through the nozzle. In some embodiments, the opening of the nozzle is adjustable. As the opening of the nozzle is made larger, the microencapsulated catnip oil is dispensed therethrough as a stream. As the opening of the nozzle is made smaller, the microencapsulated catnip oil is dispensed therethrough as an aerosolized mist. An intermediate opening of the nozzle causes the microencapsulated catnip oil to be dispensed from the nozzle as a spray.

Daubers

Daubers are instruments typically used to mark or apply liquids onto surfaces in a larger quantity than, say, a pen. Daubers are typically associated with smearing larger amounts of liquids onto surfaces. In that regard, daubers have their own liquid source and a tip comprising porous, pressed fibers, such as felt or nylon or a sponge. Liquid flows from the liquid source through the tip when the tip is placed into contact with an external source. The liquid source is typically a reservoir that comprises the body of the dauber itself, such that there is no need for a dauber to have any additional liquid-containing reservoir.

In their broadest sense, daubers are bottles capable of holding liquid that have a porous tip covering the open end of the bottle. Liquid flows from the bottle, through the tip, and onto an external source when in use. Daubers are traditionally cylindrical in shape, although variations on the shape are common. Typically, the bottle is filled with a desired liquid and the tip is placed onto the bottle and secured in place. Application of the liquid is as simple as inverting the dauber so that the material comprising the tip is contacted with the liquid, and then contacting the tip with an external source. The liquid moved from the bottle to the external surface by gravity aided by capillary action. The tip is usually contained within a housing that secured the tip to the bottle. The housing can secure the tip by any number of means including, for example, by directional, screw-like threading, a press-fit, a snap-fit, an O-ring, or any combination of the foregoing. The most commonly used housing utilizes directional, screw-like threading so that the housing is screwed onto the top of the bottle and secured in place. The tip is located in the housing such that one side of the tip faces the interior of the bottle and a different side of the tip is exposed to the air.

Daubers are well known and commonly used. Examples of daubers include Primo® Bingo markers, DOLLARDAYS® Bazic Bingo Markers, Sparco® Envelope Sealers, and the like.

In various aspects, the present disclosure provides a marker comprising microencapsulated catnip oil. In that regard, the microencapsulated catnip oil is used in the marker in place of ink. When in use, the tips of the markers of the present disclosure draw microencapsulated catnip oil from a microencapsulated catnip oil source, through the tip, and out of the marker to an external source. In that regard, the markers provided by the present disclosure “write” microencapsulated catnip oil.

In certain embodiments, the present disclosure provides a dauber comprising its own source of microencapsulated catnip oil and a tip. In some embodiments, the tip comprises porous, pressed fibers selected from felt and nylon. In some embodiments, the tip comprises a highly porous material, such as a sponge. In some embodiments, microencapsulated catnip oil flows from the source of microencapsulated catnip oil through the tip when the tip is placed into contact with an external source. In some embodiments, the source of microencapsulated catnip oil is a self-contained reservoir that terminates at the tip such that the tip is the only direction for microencapsulated catnip oil to flow from the reservoir. In both embodiments, the source of microencapsulated catnip oil is also the body of the dauber.

In certain embodiments, the present disclosure provides a dauber comprising an elongated body that is closed at one end and configured to contain a volume of microencapsulated catnip oil, a tip, and a housing for the tip. In certain embodiments, the housing secures the tip to the open end of the elongated body and places the tip in fluid connection with the microencapsulated catnip oil. In some embodiments, the housing also seals the open end of the elongated body, leaving only the tip exposed. In certain embodiments, the microencapsulated catnip oil flows from the body, through the tip and out of the dauber to an external source. The external source may include, for example, paper, cardboard, paperboard, and the like. In some embodiments, the dauber comprises a cap configured to cover the tip.

In certain embodiments, the present disclosure provides a dauber comprising a container having a single opening and that is configured to contain a volume of microencapsulated catnip oil, a tip, and a housing for the tip. In certain embodiments, the housing comprises a cap that is configured to house the tip and completely close off the opening of the container. The cap may be secured in place at the opening by any number of means including, for example, directional screw-like threading, a press fit, an O-ring, and the like. In certain embodiments, the housing secures the tip to the opening of the container such that one side of the tip faces the interior of the container and another side of the tip is exposed to the air. In some embodiments, the housing seals the opening of the container, leaving only one side of the tip exposed. In certain embodiments, the tip comprises an absorbent material selected from cotton, wool, felt, nylon and combinations thereof. In some embodiments, the tip comprises a sponge. In certain embodiments, the microencapsulated catnip oil flows from the container, through the tip and out of the dauber to an external source. The external source may include, for example, paper, cardboard, paperboard, and the like. In some embodiments, the dauber comprises a cap configured to cover the tip.

The volume of the containers of the daubers can vary. In some embodiments, the daubers are configured to contain a volume of microencapsulated catnip oil from 0.25 milliliters to 100 milliliters (mL). In some embodiments, the daubers are configured to contain a volume of microencapsulated catnip oil from 2 mL to 50 mL. In some embodiments, the daubers are configured to contain a volume of microencapsulated catnip oil from 5 mL to 25 mL.

Methods of Use

In various aspects, the present disclosure provides methods of using the microencapsulated catnip oil provided by the present disclosure.

In some embodiments, methods of spraying paper with microencapsulated catnip oil are provided. In certain embodiments, the methods comprise:

spraying microencapsulated catnip oil onto a single side of a first piece of paper;

spraying microencapsulated catnip oil onto a single side of a second piece of paper;

placing the sprayed side of the first piece of paper in contact with the sprayed side of the second piece of paper; and

separating the first and second pieces of paper.

In some embodiments, the microencapsulated oil is formulated in a solution and is applied to the first and second pieces of paper wet. In some embodiments, the methods include a step of drying between the placing and the separating steps, to allow the microencapsulated catnip oil to dry while the first and second pieces of paper are in contact with each other.

In some embodiments, the microencapsulated catnip oil comprises an adhesive that acts to hold the first and the second pieces of paper in contact with each other until the step of separation. In certain embodiments, the adhesive located on the surface of the microcapsules of the microencapsulated catnip oil holds the first piece of paper in place on one side of the microcapsules and holds the second piece of paper in place on the opposite side of the microcapsules.

In some embodiments, the step of separation provides sufficient mechanical stress on the microcapsules that some of them break, releasing the microencapsulated catnip oil. In some embodiments, about 25% of the microcapsules break. In some embodiments, about 50% of the microcapsules break. In some embodiments, about 75% of the microcapsules break. In some embodiments, the step of separation provides sufficient mechanical stress on the microcapsules that all of them break. In each of the foregoing embodiments, breaking the microcapsules releases the microencapsulated catnip oil.

The spraying of the microencapsulated catnip oil can be accomplished in any one or more of a variety of ways. In some embodiments, the spraying is accomplished by use of a hand powered spray bottle, as disclosed herein. In some embodiments, the spraying is accomplished by use of a hand powered atomizer, as disclosed herein. In some embodiments, the spraying is accomplished by use of a hand powered squirt gun. In some embodiments, the spraying is accomplished by use of an air brush.

In certain embodiments, the methods comprise:

spraying a wet solution of microencapsulated catnip oil onto a single side of a first piece of paper;

spraying a wet solution of microencapsulated catnip oil onto a single side of a second piece of paper;

placing the sprayed side of the first piece of paper in contact with the sprayed side of the second piece of paper;

allowing the wet solution of microencapsulated catnip oil to dry; and

separating the first and second pieces of paper;

wherein the microencapsulated catnip oil comprises comprising a plurality of microcapsules of catnip oil and an adhesive;

wherein the adhesive holds the sprayed side of the first piece of paper in contact with the sprayed side of the second piece of paper until the step of separating; and

wherein the separating breaks at least about 75% of the microcapsules of the microencapsulated catnip oil.

In some embodiments, the present disclosure provides a first piece of paper in contact with a second piece of paper with at least a single sprayed layer of microencapsulated catnip oil sandwiched between the first and the second pieces of paper. In certain embodiments, this apparatus is produced using one of the methods disclosed herein and in some embodiments, the step of separating has not yet been performed. In some embodiments, the generation of the apparatus is accomplished by a person or entity separate and distinct from the person or entity who performs the step of separating.

Finally, it should be noted that there are alternative ways of implementing the embodiments disclosed herein. Accordingly, the present embodiments are to be considered as illustrative and not restrictive. Furthermore, the claims are not to be limited to the details given herein, and are entitled their full scope and equivalents thereof.

1. A marker, comprising:
a cylindrical outer case closed at one end;
a source of microencapsulated catnip oil;
a tip; and
a housing.

2. The marker of claim 1, wherein the source of microencapsulated catnip oil fits inside of, and is completely contained within, the outer case and the microencapsulated catnip oil is configured to flow from the source to the tip and out of the marker.

3. The marker of claim 1, wherein the housing secures the tip to the open end of the outer case and places the tip in fluid connection with the source of microencapsulated catnip oil.

4-5. (canceled)

6. The marker of claim 1, wherein the tip comprises porous pressed fibers selected from felt and nylon.

7. The marker of claim 1, wherein the source of microencapsulated catnip oil comprises a reservoir.

8. The marker of claim 1, wherein the microencapsulated catnip oil comprises microcapsules having a diameter falling within the range of 5 μm-60 μm.

9. The marker of claim 1, wherein the microencapsulated catnip oil comprises microcapsules having a diameter falling within the range of 5 μm-10 μm.

10. (canceled)

11. The marker of claim 1, wherein the source comprises a cartridge made of an absorbent material selected from cotton, wool, felt, nylon and combinations thereof and the cartridge is soaked in a solution comprising the microencapsulated catnip oil.

12-13. (canceled)

14. A felt tip pen, comprising:
a cylindrical outer case closed at one end;
a source of microencapsulated catnip oil;
a tip; and
a housing.

15. The felt tip pen of claim 14, wherein the source of microencapsulated catnip oil fits inside of, and is completely contained within, the outer case and the microencapsulated catnip oil is configured to flow from the source to the tip and out of the felt tip pen.

16. The felt tip pen of claim 14, wherein the housing secures the tip to the open end of the outer case and places the tip in fluid connection with the source of microencapsulated catnip oil.

17-18. (canceled)

19. The felt tip pen of claim 14, wherein the tip comprises porous pressed fibers selected from felt and nylon.

20. The felt tip pen of claim 14, wherein the source of microencapsulated catnip oil comprises a reservoir.

21. The felt tip pen of claim 14, wherein the microencapsulated catnip oil comprises microcapsules having a diameter falling within the range of 5 μm-60 μm.

22. The felt tip pen of claim 14, wherein the microencapsulated catnip oil comprises microcapsules having a diameter falling within the range of 5 μm-10 μm.

23. (canceled)

24. The felt tip pen of claim 14, wherein the source comprises a cartridge made of an absorbent material selected from cotton, wool, felt, nylon and combinations thereof and the cartridge is soaked in a solution comprising the microencapsulated catnip oil.

25-59. (canceled)

60. A method of spraying paper with microencapsulated catnip oil, comprising:
spraying microencapsulated catnip oil onto a single side of a first piece of paper;
spraying microencapsulated catnip oil onto a single side of a second piece of paper;
placing the sprayed side of the first piece of paper in contact with the sprayed side of the second piece of paper; and
separating the first and second pieces of paper.

61. (canceled)

62. The method of claim 61, comprising, after the step of placing, drying the microencapsulated catnip oil.

63. The method of claim 60, wherein the microencapsulated catnip oil comprises a plurality of microcapsules of catnip oil and an adhesive.

64. The method of claim 63, wherein the adhesive holds the sprayed side of the first piece of paper in contact with the sprayed side of the second piece of paper until the step of separating and the step of separating breaks at least about 75% of the microcapsules of the microencapsulated catnip oil.

65. (canceled)

66. The method of claim 60, the microencapsulated catnip oil comprises microcapsules having a diameter falling within the range of 5 μm-60 μm.

67. The method of claim 60, wherein the microencapsulated catnip oil comprises microcapsules having a diameter falling within the range of 5 μm-10 μm.
